(19) United States
(12) Patent Application Publication
(10) Pub. No.: US 2005/0177386 A1
(43) Pub. Date: Aug. 11, 2005

(54) System and method to facilitate the ordering of a pre-release electronic title

(76) Inventor: Yazeed Mansi Essa, Gates Mills, OH (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/878,823

(22) Filed: Jun. 28, 2004

Related U.S. Application Data
(60) Provisional application No. 60/543,738, filed on Feb. 11, 2004.

(51) Int. Cl. G06F 17/60

(52) U.S. Cl. 705/1

(57) ABSTRACT

A system and/or method that enables a user to preorder electronic titles prior to release for sale or rental. One embodiment is directed toward a system (and method thereof) configured to enable a user to preorder a desired electronic title (e.g., digital versatile discs or digital video discs (DVDs), compact discs (CDs)) at a venue-specific location prior to public release. The present system and method can be used in relation to any electronic title available on any format known in the art including, but not limited to DVDs, CDs, magnetic tapes, streaming audio/video or the like. As well, the present system and method may be used in relation to any type of electronic title known in the art including but, not limited to movies, music, software, games, news, magazines, periodicals, newspapers or the like.

### CROSS-REFERENCE TO RELATED APPLICATIONS

This application claims priority under 35 U.S.C. § 119(e) from U.S. Provisional Patent application Ser. No. 60/543,738 entitled “SYSTEM AND METHOD TO ORDER PRODUCTS” and filed Feb. 11, 2004.

### TECHNICAL FIELD

This invention is related generally to electronic titles, and more particularly to a system and/or method to facilitate the process of an order related to an electronic title (e.g., motion pictures, soundtracks, arcade-type games, video games, software, periodical).

### BACKGROUND OF THE INVENTION

With the technological advances in electronic multimedia and electronic titles, there is an ongoing and increasing need to facilitate and expedite the process of ordering electronic titles (e.g., motion pictures, soundtracks, arcade-type games, video games, software) in venue-specific locations thereby capturing impulse purchases and increasing sales.

Traditionally, vending systems introduced methods and machines for vending products, such as snacks, soft drinks, cigarettes and newspapers. Today, vending machines are used to dispense other items ranging from currency to postage stamps.

On the other hand, concession areas of venue-specific locations are sometimes available to provide a limited selection of items to patrons. For example, products available at show locations such as cinemas (e.g., movie theaters) and concert venues generally frequently include food items, refreshments, and wearing apparel. Sometimes, particularly in concert venues, “currently-released” music recordings may be available for purchase. However, traditionally, venue-specific retail outlets have not been directed toward the sale (e.g., face-to-face, electronic vending, or otherwise) of pre-release electronic titles (e.g., movies, music, software).

In recent years, digital electronic titles has increasingly become commonplace as the present state-of-the-art for recording video, music and software. The advanced development of relatively inexpensive portable digital media player devices has led to a substantial increase in the demand for digital electronic titles.

As well, the ever-increasing demand to purchase digital electronic titles prior to public release has become an emerging market. Conventionally, methods do not exist to facilitate the pre-purchase or preorder of an electronic title prior to knowledge of a date of availability and/or release for sale or rental. More particularly, pre-purchase, preorder and/or backorder methods and systems do not exist in industry specific venues (e.g., cinema, concert venue, arcade). In other words, today's marketplace (e.g., cinema, concert venue concession/retail area) does not utilize any method and/or system to enable a consumer to pre-purchase, preorder and/or backorder a selected electronic title prior to public release and/or availability.

In view of the emerging demand to obtain digital electronic titles and products as soon as practicable and to mitigate the aforementioned concerns, there remains a need for a system and/or method to enable a consumer to preorder a desired electronic title selection prior to public release.

Additionally, there remains a substantial unmet need to facilitate a consumer to purchase pre-release electronic title at venue-specific locations (e.g., cinema, concert venues, arcades). Specifically, there exists a need for a system and/or methodology to permit the preorder of a multitude of electronic titles including, but not limited to, motion picture video, music, periodicals, newspapers and software (e.g., games, electronic and productivity software).

### SUMMARY OF THE INVENTION

One embodiment of the present invention is directed toward a method of preordering electronic titles or products prior to knowledge of a date of availability and/or release for sale and/or rental. It will be appreciated that an order as discussed herein can be an order to effectuate a purchase, rental, private screening, or the like of an electronic title. Another embodiment is directed toward a vending machine (and method thereof) configured to enable a user to preorder a desired electronic title (e.g., digital versatile discs or digital video discs (DVDs), compact discs (CDs)) at a venue-specific location prior to public release. Of course, the present system and method can be used in relation to any electronic title available on any format known in the art including, but not limited to DVDs, CDs, magnetic tapes, streaming audio/video or the like. As well, the present system and method may be used in relation to any type of electronic title known in the art including but, not limited to movies, music, software, games, news, magazines, periodicals, newspapers or the like.

The present invention disclosed and claimed herein, in one aspect thereof, defines a method for ordering an electronic title prior to release for public purchase or rental. The method includes the acts of entering a cinema and initiating an order for the electronic title. In connection with the initiation of the order, the method can include the act of obtaining a ticket, coupon or voucher having a unique identifier (e.g., bar code, serial number) whereby the voucher can be redeemed to initiate the order. It will be appreciated that the method can include a computer readable medium having computer-executable instructions to perform the acts of the methods disclosed herein.

Another aspect of the present invention discloses a system that facilitates pre-release ordering of an electronic title. Specifically, the system can have a pre-release order component (e.g., remotely or venue-specifically located) that receives and processes a pre-release order for a product and an order tracking component that monitors the process of the pre-release order. By way of example, the system can be located in a movie theater or cinema.

In accordance with an aspect of the system, a pre-release order data store that retains the pre-release order can be provided. Additionally, an available product data store that retains a listing of available products can be provided to assist in the process.

A transmission component can be provided to transmit the pre-release order to a remote processing location if desired. As well, a dispatch component that dispatches the product in accordance to the pre-release order can be utilized to deliver the ordered electronic title.

In yet another aspect of the present invention, an alternate method for ordering an electronic title prior to public release is provided. The method can be initiated by receiving a request for a product prior to public release. It is contemplated that the request can be initiated in a venue-specific location (e.g., cinema). As well, initiation of the request can include decoding a unique identifier.

A query can be performed to determine availability for the product. If the product is available, it can be dispatched in accordance with a user defined criteria. If the product is not available, the request can be stored and queried to assist in processing the request. Once available, the product can be dispatched in accordance to the initial request.

The method set forth in claim 15, further comprising querying the stored requests to determine availability of the product. Payment for the electronic title can be tendered and/or validated in any manner known in the art.

In another aspect of the invention, a system for obtaining an electronic title prior to release is provided. The system includes means for entering a pre-release order for the electronic title and means for processing the pre-release order. The means for entering the pre-release order can have means for initiating the pre-release order at a venue-specific location (e.g., means for recognizing a unique identifier).

The system can further include means for tendering and validating payment. Additionally, the system can have means for querying availability of the electronic title.

In yet another embodiment of the present invention, a method of ordering an electronic title corresponding to an event is provided. The method can be initiated by entering a venue (e.g., cinema) of the event. One aspect can require actual attendance to the showing and/or performance of the event. Next, payment can be tendered in correspondence to an entry fee to the event. While at the venue, an order for the electronic title can be initiated, wherein the electronic title is a record of one or more aspects of the event. Payment of the entry fee and the act of initiating the order for the electronic title can be detected thus initiating a delivery of the electronic title.

It is contemplated in accordance to an aspect of the present invention that the method, and/or individual acts thereof, can be employed in a person-to-person, person-to-machine, machine-to-person or machine-to-machine manner as desired. Furthermore, customer information can be provided when initiating the order whereby the customer information can be included onto a voucher issued in connection with the order.

To the accomplishment of the foregoing and related ends, certain illustrative aspects of the invention are described herein in connection with the following description and the annexed drawings. These aspects are indicative, however, of but a few of the various ways in which the principles of the invention can be employed and the present invention is intended to include all such aspects and their equivalents. Other advantages and novel features of the invention can become apparent from the following detailed description of the invention when considered in conjunction with the drawings.

### BRIEF DESCRIPTION OF THE DRAWINGS

FIG. 1 illustrates a general component architectural diagram of a pre-release ordering system in accordance with an aspect of the invention.

FIG. 2 illustrates a flow chart of procedures to order pre-release electronic titles in accordance with an aspect of the disclosed invention.

FIG. 3 illustrates a general component architectural diagram that illustrates representative network components in accordance with a disclosed embodiment.

FIG. 4 illustrates a general component architectural diagram that illustrates representative network components in accordance with a disclosed embodiment.

FIG. 5 illustrates a flow chart of procedures to order pre-release electronic titles in accordance with an aspect of the disclosed invention.

FIG. 6 illustrates a device operable to execute an aspect of the disclosed invention.

FIG. 7 illustrates a network architecture operable to execute an aspect of the present invention.

FIG. 8 illustrates a flow chart of procedures to initiate an order for electronic titles in accordance with an aspect of the disclosed invention.

FIG. 9 illustrates a system block diagram of a computer operable to execute the disclosed embodiment.

### DETAILED DESCRIPTION OF THE DISCLOSED EMBODIMENTS

The present invention is now described with reference to the drawings, wherein like reference numerals are used to refer to like elements throughout. In the following description, for purposes of explanation, numerous specific details are set forth in order to provide a thorough understanding of the present invention. It can be evident, however, that the present invention can be practiced without these specific details. In other instances, well-known structures and devices are shown in block diagram form in order to facilitate describing the present invention.

The following terms are used throughout the description, the definitions of which are provided herein to assist in understanding various aspects of the subject invention. As used in this application, the terms “component” and “module” are intended to refer to a computer-related entity, either hardware, a combination of hardware and software, software, or software in execution. For example, a computer component or module can be, but is not limited to being, a process running on a processor, a processor, an object, an executable, a thread of execution, a program, and/or a computer. By way of illustration, both an application running on a server and the server can be a computer component. One or more computer components can reside within a process and/or thread of execution and a component can be localized on one computer and/or distributed between two or more computers. Further, it is contemplated that the invention described herein includes the methods or acts associated with the components and/or modules described herein.

Generally, one aspect of the present invention is directed to the timing of the transaction and facilitates the ordering process prior to availability or for sale or rental release date, or knowledge thereof, of the electronic title or product for rental and/or purchase. Another aspect of the present invention is directed to the location of the transaction and facilitates the ordering process in a venue-specific location (e.g., cinema, concert hall, arcade).

One aspect of the present invention provides for a system and/or methodology configured to facilitate the venue-specific ordering of a pre-release electronic title or product (e.g., movie, soundtrack, arcade-type game). In other words, an aspect of the present system and method provides for a system and method suitably adapted to facilitate the user to order and/or back-order a desired electronic unit prior to any announcement of availability and/or release for sale and/or rental. Additionally, in accordance with the present invention, it is contemplated that the transaction can be initiated within a venue-specific location (e.g., cinema, concert hall, arcade) or via remote means (e.g., Internet).

By way of example, following the screening of a motion picture in a cinema or theater, a viewer often desires to obtain a copy of the movie for home viewing. However, in most cases, the movie has not yet been released for public purchase. Additionally, in most instances, the date of release for sale and/or rental has not been disclosed to the public. The present innovation contemplates and discloses a system and/or method to effectuate the ordering, preordering and/or backordering of an electronic title prior to availability or public release for rental and/or purchase. It will be appreciated that, in accordance with an embodiment of the present invention, the transaction can be effectuated in any known manner prior to any knowledge of release date. For example, the transaction can be initiated in a person-to-person manner (e.g., concession area) or via electronic means (e.g., Internet or other suitable electronic device).

Once available and/or publicly released, an embodiment of the present system and method contemplates order tracking and subsequent delivery of the desired product. Although the present embodiments are directed toward delivery of tangible medium, it is to be understood that any method of transfer known in the art can be employed without departing from the spirit and scope of the present invention. By way of example, the system and/or method can be configured to employ digital transfer techniques via streaming video/audio or the like.

One embodiment of the present innovation is directed toward a method of effectuating the preorder and/or backorder of a video product. As discussed above, one embodiment of the present innovation contemplates the order, preorder and/or backorder of a video product prior to public release and/or prior to any knowledge of release date. The methods described herein can be employed person-to-person (e.g., cinema or concert venue concession area) or via electronic and/or remote means (e.g., PDA, handheld device, Internet).

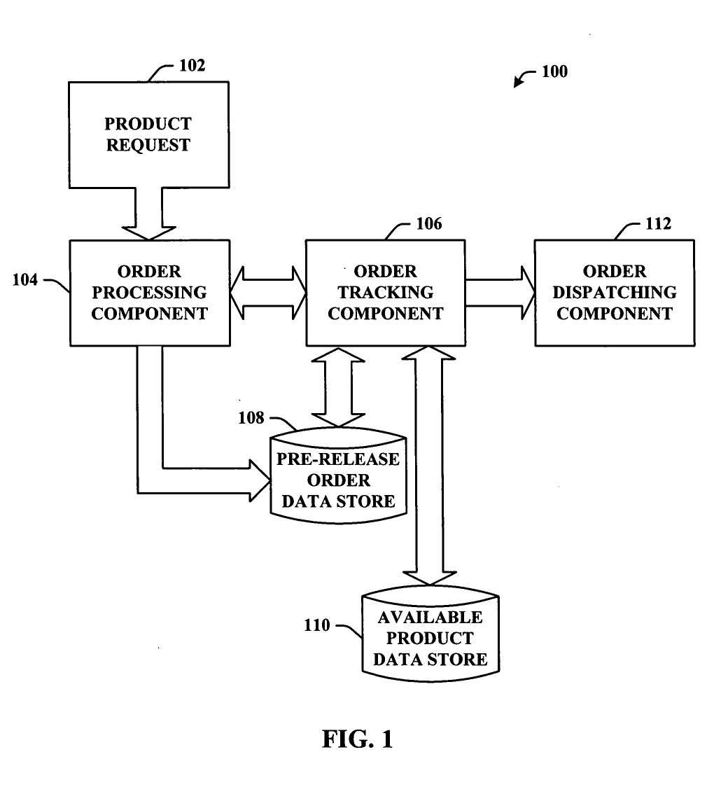

Referring initially to FIG. 1, a general block schematic diagram of a pre-release ordering system 100 in accordance an embodiment of the present invention is shown. Generally, the pre-release ordering system 100 can be suitably configured to receive and process a product request 102 thereby effectuating the order through utilization of an order processing component 104 and an order tracking component 106.

The order processing component 104 can be configured to facilitate the method of receiving the product request 102 from any suitable means known in the art. It will be appreciated that the product request 102 can be entered via any means known in the art including, but not limited to, manual or automatic input. By way of example, the product request 102 can be generated and input via a cellular telephone or other suitable portable electronic device. As well, the product request 102 can be generated by an operator manually inputting the product request 102 in order to initiate the ordering process.

Although the current embodiment is directed to a system and corresponding components, those skilled in the art will appreciate that the scope of the disclosure is intended to encompass the methods and acts to employ the functionality described herein.

Again with reference to FIG. 1, it will be appreciated that the order processing component 104 can be configured to facilitate the method of storing the product request 102 in a pre-release order data store 108. An artisan will appreciate that any data store or memory source known in the art can be used without departing from the spirit and scope of the present invention. The data and information stored in the pre-release data store 108 can be maintained for utilization by the order tracking component 106.

Once the order is entered, processed and optionally stored by the order processing component 106, the tracking component 106 illustrated in FIG. 1 can be configured to facilitate the method of periodically querying available electronic titles in furtherance of completing the ordering process. By way of example, the order tracking component 106 can be configured to query an available product data store 110 to determine availability of a desired product. Once it is determined that the desired product becomes available, an order dispatch component 112 can be utilized to dispatch the desired product to the requestor.

It is contemplated that the systems and methods disclosed and described herein can be physically employed in a specific venue corresponding to the desired electronic title or event. By way of example, if the electronic title is a motion picture or movie, it is understood that the present invention can be practiced within the motion picture's venue-specific location (e.g., cinema). In another embodiment, the present invention can be practiced within an arcade or concert hall corresponding to a video game or musical performance respectively. It will be appreciated that the present invention can be practiced in connection with any venue corresponding to any type of electronic title.

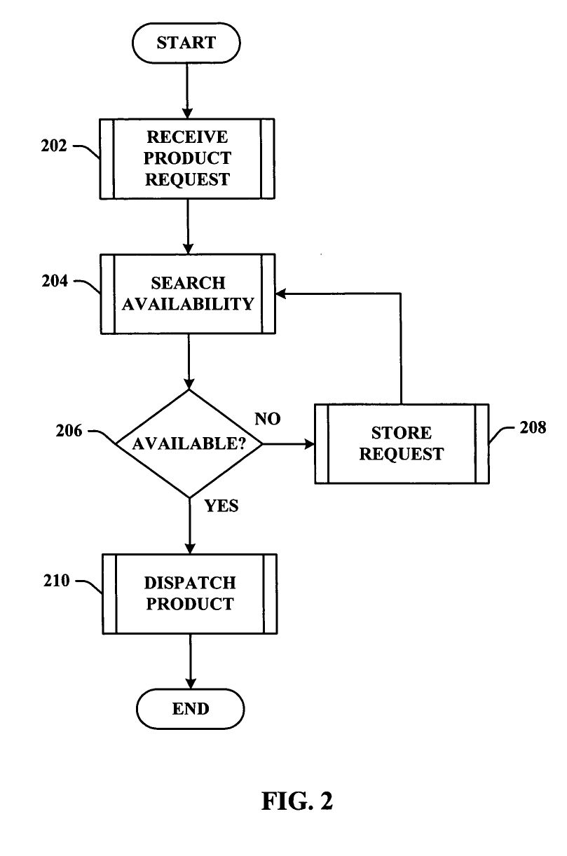

FIG. 2 illustrates a methodology for entering an order for a pre-release electronic title and subsequently processing and tracking the order in accordance with an aspect of the present invention. While, for purposes of simplicity of explanation, the one or more methodologies shown herein, e.g., in the form of a flow chart, are shown and described as a series of acts. It is to be understood and appreciated that the present invention is not limited by the order of acts, as some acts can, in accordance with the present invention, occur in different orders and/or concurrently with other acts from those shown and described herein. For example, those skilled in the art will understand and appreciate that a methodology could alternatively be represented as a series of interrelated states, such as in a state diagram. Moreover, not all illustrated acts can be required to implement a methodology in accordance with an aspect the present invention.

Referring to FIG. 2, and proceeding to 202, a product request is received. As described above, an order processing component can be utilized to process the request. Further, as described above, any method known in the art can be utilized to input the request. By way of example, in addition to person-to-person communication, the input method can include, but is not limited to, devices such as keypads, touchpads, scanners and microphones. Additionally, the input method can be manual or automatic based upon an unlimited number of optional entry methods.

At 204, the system searches availability of the requested product. Specifically, at 206, the system determines if the selected product is available. If at 204 the system determines that product is not available, the request is stored at 208. It will be appreciated that the request can be stored together with user specific identification data. In accordance with storing the request at 208, those skilled in the art will appreciate that an order tracking component 106 from FIG. 1 can be used to proceed the order.

As illustrated in FIG. 2, the system can return to 204 thereby searching the availability of the desired product. This cycle can continue until the product becomes available. Alternatively, the system can optionally be set to time-out after a predetermined time period has elapsed.

Once the desired product becomes available, the product can be dispatched to the requestor at 210. It is contemplated that any method of dispatch can be utilized in accordance with alternate aspects of the present invention including, but not limited to, via conventional mail, express mail, electronic delivery (e.g., Internet, wireless, wired network) or the like.

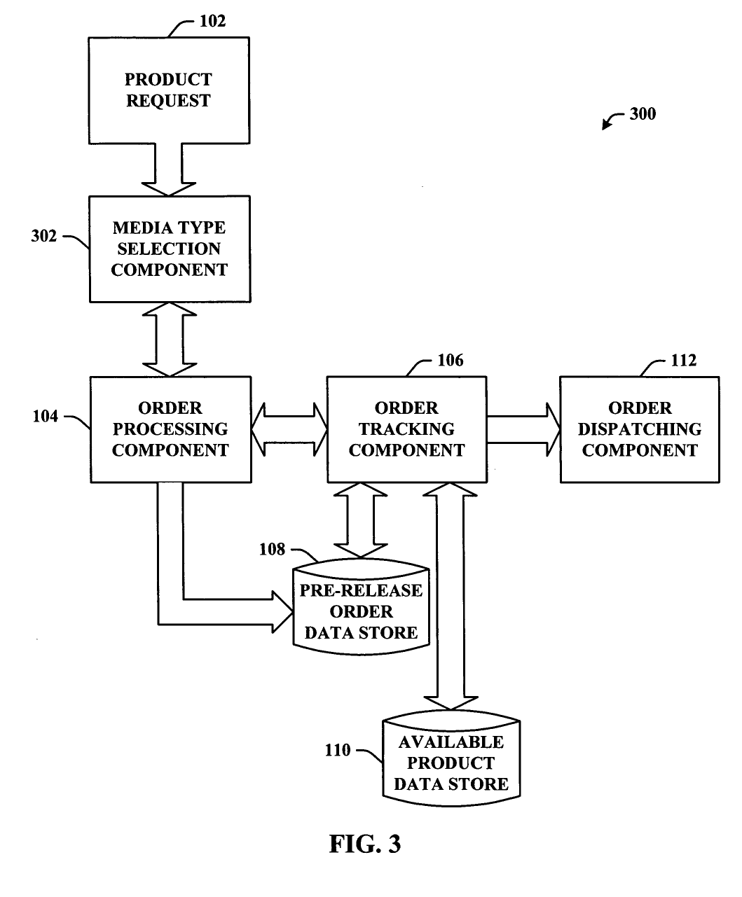

Referring now to FIG. 3, an alternate embodiment of the present system and method is shown. Generally, FIG. 3 illustrates a pre-release ordering component 302 for processing a product request 102. More particularly, the pre-release ordering system 300 can include an electronic title type selection component 302 configured to facilitate a method of selecting the type of desired electronic title or product (e.g., DVD, CD, magnetic tape, streaming audio/video) to be dispatched via the order dispatching component 112.

With continued reference to FIG. 3, the order processing component 104, order tracking component 106, pre-release order data store 108, available product data store 110 and the order dispatching component 112 can be suitably configured and employed as described above with reference to FIG. 1. Once obtained, the order dispatching component 112 can facilitate the delivery of the desired electronic title to the requestor.

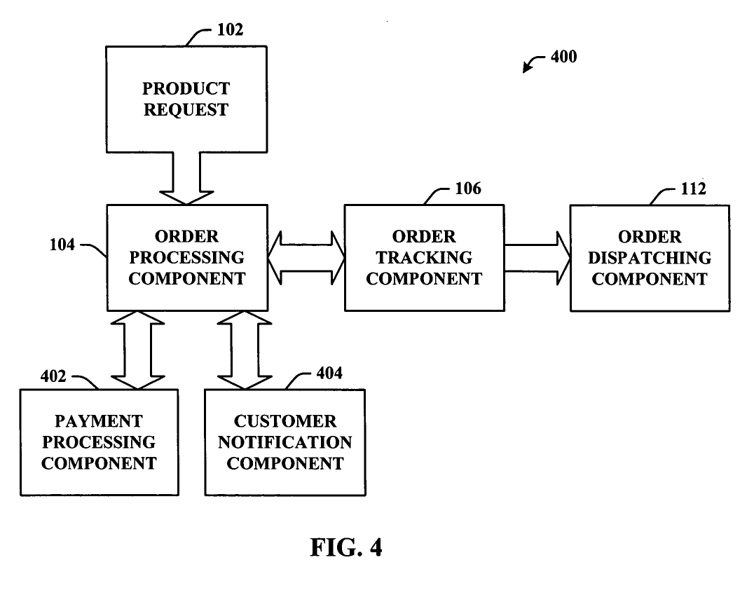

FIG. 4 illustrates yet another embodiment of the present system and methodology. In accordance with the pre-release ordering component 400 illustrated in FIG. 4, a payment processing component 402 and a customer notification component 404 are provided.

The payment processing component 402 can be configured to facilitate the validation of a monetary or credit transaction. By way of example, the payment processing component 402 can be configured to calculate currency inputted and subsequently dispense change if appropriate.

The customer notification component 404 can be configured to notify a requestor of the status of an order. For instance, the customer notification component 404 can be configured to facilitate the method of notifying a customer of the proposed dispatch date of a requested product. It will be appreciated that any notification method known in the art can be utilized including but, not limited to, email, telephone, text messaging or the like.

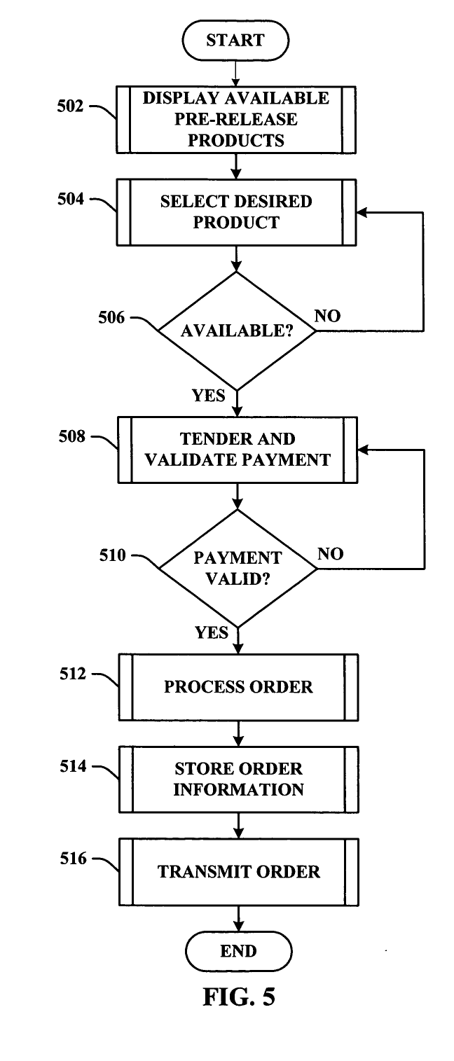

Illustrated in FIG. 5 is another embodiment of a methodology associated with entering and processing an electronic title order in accordance with the present innovation. Although the methodology of FIG. 5 will be described with reference to a credit card payment for the order of desired electronic title, it is contemplated that any the method can be employed without departing from the functionality of the present invention.

At 502, the process is commenced upon displaying the available pre-release electronic titles. Next, at 504, a desired product is selected. Once the desired product is chosen, the system determines if the desired product is available at 506. It will be appreciated that, at 506, the system can be suitably configured to determine if the desired product is available in a selected format (e.g., DVD, VCR magnetic or digital multimedia).

If the desired product is not available or not available in the specific desired format, the system returns to 504 and prompts for another selection as illustrated in FIG. 5. If, at 506, the desired product is available, the system prompts for the tender of payment at 508. Additionally, at 508, the system validates of the selected method of payment. If at 510 a determination is made that payment is not valid, the system returns to 508 and subsequently prompts for payment.

Once validated, the system processes the order at 512. It will be appreciated that processing the order can include any methods and/or acts customary and known in the art as related to retail purchases. Optionally, the system may store the order information for archive and/or later retrieval.

Finally, the system can be configured to transmit the order to a desired remote location at 516. For example, the system can be configured to transmit a validated order to a warehouse for later delivery or dispatch of the selected electronic title.

It will be appreciated that the methodology of FIG. 5 is illustrative of an embodiment only and can include additional or less acts involved in the retail process without departing from the pre-release purchase, preorder and/or backorder innovations discussed herein. It will be appreciated that the acts to enable the novel processes discussed herein may include any customary acts known in the related industries.

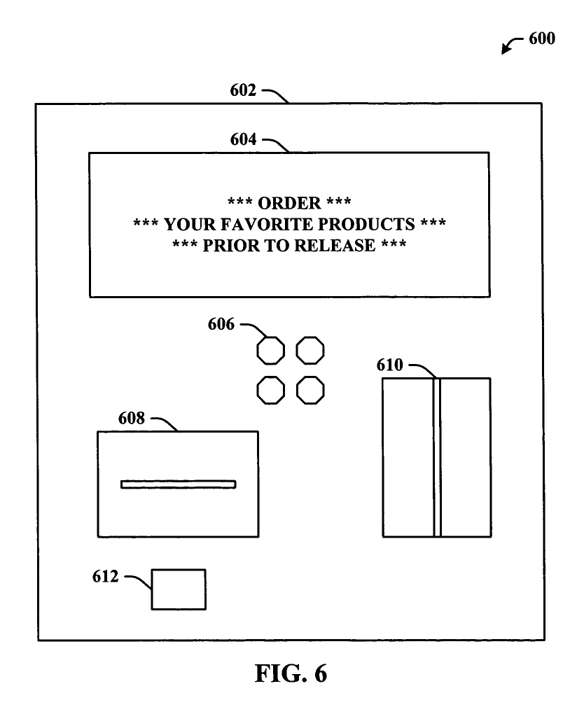

Turning now to FIG. 6, a system and apparatus, in accordance with one embodiment, to order a pre-release electronic title is shown. Specifically illustrated in FIG. 6 is an apparatus 600 suitably adapted to facilitate a user to order electronic titles. As discussed herein, it is contemplated that the disclosed system and/or methodology can be employed in a venue-specific location (e.g., cinema, concert venue, arcade).

One embodiment of an apparatus 600 can include a housing 602 to house the components of the apparatus 600. Generally, as illustrated, a monitor 604 to display a graphical user interface (GUI) can be provided in a location suitably accessible to a user. It will be appreciated that the monitor 604 can be any monitor known in the art including but, not limited to liquid crystal display (LCD), projection, tube or the like. Further, it will be appreciated that the monitor 604 can be used to facilitate a preview of available electronic title selections.

A selection panel 606 can be provided to enable a user to navigate through programmed menus provided via the GUI projected via the monitor 604. As well, payment acceptors 608 and 610 can be provided to enable a user to tender adequate payment in accordance with the selected electronic title. It will be appreciated that additional payment methods may be used in accordance with the present system. As such, alternate mechanisms and components can be suitably provided to facilitate an alternate payment method.

As shown, a paper currency acceptor 608 is provided to accept paper currency. A change return discharge 612 can be provided to tender change to a user. As well, a credit card payment acceptor 610 can be provided to enable a user to pay via credit or debit card. Of course, prepaid cards and other forms of payment (e.g., tokens, vendor-specific bar code and/or magnetic cards, checks, prepaid accounts, wireless phone account and other identification devices) known in the art can be adapted and incorporated into the present invention without departing from the spirit and scope of the invention.

In an alternate embodiment, it will be appreciated that the system can be configured to accept payment utilizing known wireless technologies. By way of example, in accordance with alternate embodiments, it will be appreciated that wireless telephones, personal digital assistants (PDAs) (e.g., Palm™ pilots, Blackberry™ units) or the like can be employed to communicate an order directly to a central processing station via wireless techniques thereby deferring payment to pre-established payment techniques (e.g., bank accounts, credit cards).

In operation, the paper currency acceptor 608 can be adapted to accept paper currency in predefined denominations selected by the apparatus operator. A currency logic can be adapted to communicate the denomination to a control logic whereby the amount due can be processed with respect to the amount tendered in accordance with the desired selection.

In other words, once a user makes a selection via the GUI, the control logic can be configured to process the amount due as well other applicable factors (e.g., availability date, dispatch lead-time). It will be appreciated that a database storage element may be queried to supply such information.

Once the payment is verified, the control logic can be adapted to communicate with a communication logic to transmit the user's order to a predetermined location. It will be appreciated that an optional database storage unit can be utilized in conjunction or in lieu of the communication logic to store order information on a computer readable medium for later retrieval and/or transmission.

In accordance with an embodiment, the selection panel 606 can be configured with navigation devices (e.g., joystick, touchpad) to facilitate the user to enter the identification of a desired electronic title.

Those skilled in the art will appreciate that the system and method may also be accomplished remotely without departing from the spirit and scope of the present innovation. For example, ordering, preordering or back-ordering electronic titles in accordance with the present system and method may be accomplished via the world wide web or Internet. As well, telephones, Wi-Fi, personal digital assistants (PDAs) and cellular technology may be used from remote locations without departing from the innovation described herein.

Moreover, it will be appreciated that the present system and/or method can be adapted for use in connection with other well known sources of vending and/or dispensing. For example, the present system and method may be adapted and/or incorporated into existing Automated Teller Machines (ATMs) which are readily available throughout industries and public areas without departing from the spirit and scope of the present innovation.

It will further be understood that the system and method in accordance with the present innovation may include a preview logic to enable a user to preview a desired electronic title prior to purchase. For example, the preview logic can be configured to facilitate a method of enabling a user to preview a movie via the monitor 604 or to listen to a portion of a music track prior to ordering. Accordingly, it will be appreciated that the present system may be adapted to include visual (e.g., monitor, video card) and audio (e.g., speakers, amplifier, sound card) components and accessories (e.g., headphones) as needed to facilitate any such preview.

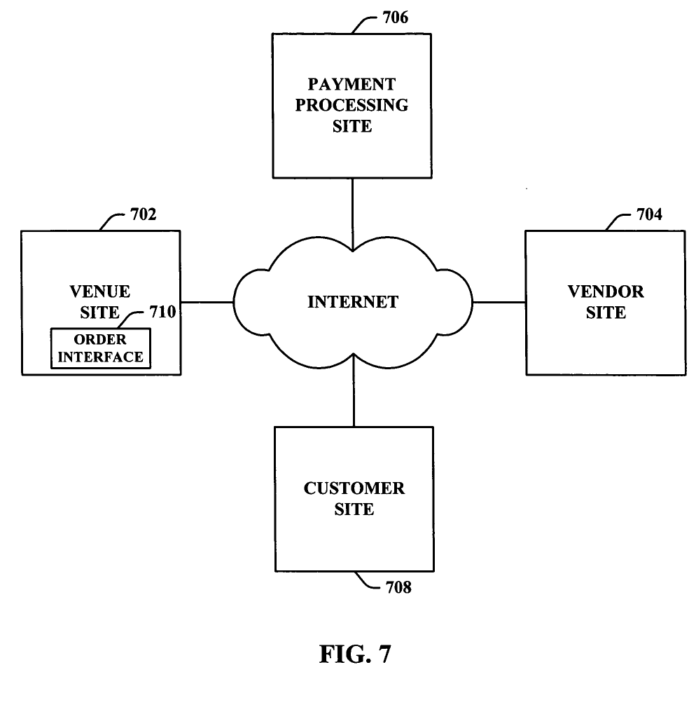

FIG. 7 illustrates an embodiment of an exemplary network architecture in accordance with an aspect of the present invention. Generally, the network can include a venue site 702, a vendor site 704, a payment processing site 706 and a customer site 708.

Although FIG. 7 illustrates individual components, those skilled in the art will appreciate that the functionality of individual components can be combined with the functionality of other components to form a single module. As well, functionality of any individual component can be eliminated from the architecture without departing from the overall spirit and scope of the invention.

As illustrated in FIG. 7, the venue site 702 can be configured to include an order interface 710. By way of example, the order interface 710 can be a human interface configured to facilitate a method of initiating an order. Alternatively, as described herein, the order interface 710 can include any electronic means known in the art capable enabling the initiation of an order.

The vendor site 704 can be configured to facilitate a method of processing the order entered via the venue site 702. The payment processing site 706 can be configured to facilitate a method of validating a method of payment, if appropriate. For example, the payment processing site 706 can be adapted to verify validity of a credit card purchase. In other embodiments, the payment processing site 706 can be configured to validate any alternate payment methods (e.g., tokens, magnetic cards, bar codes).

The customer site 708 is illustrated for ease of understanding the notification and dispatch methods as discussed above. In other words, as illustrated in FIG. 7, order notification (e.g., status) and subsequent electronic title dispatch can be effectuated via the network (e.g., Internet). It is to be appreciated that any type of network can be employed without departing from the spirit or scope of the present invention. Also, as described above, alternate notification and delivery methods can be employed including but, not limited to conventional delivery, express mail, email, streaming audio/video or the like.

In operation, one embodiment provides for a unique identifier included on a ticket, voucher, receipt, token or the like which represents the pre-purchase or option to purchase the pre-release electronic title. The identifier can be any suitable identifying technique known in the art including, but not limited to, words, numbers, color codes, bar codes, magnetic strips, radio frequency identification or the like.

In accordance with one embodiment, upon entering a cinema, a user can be given the option to later purchase the pre-release video product whereby a specific ticket can be issued to identify the purchase or option to purchase the pre-release product. It will be appreciated that incentives (e.g., discounted prices, souvenirs, keepsakes, collector's items, bonus footage and materials) can be offered in connection with the option and/or purchase. While at the cinema, the patron can redeem the option to initiate an order for the pre-release product.

In accordance with another embodiment, the patron can be required to present sufficient identification and or verification of their age to initiate an order. For example, the system and/or method can employ an electronic reader to scan a patron's driver's license to verify identification and/or age requirements to initiate an order.

Another embodiment can employ a pre-issued identification or membership card. For instance, a patron can join a video club whereby a membership card is issued. The membership card can later be used for subsequent purchases at the venue location or via remote sources (e.g., Internet).

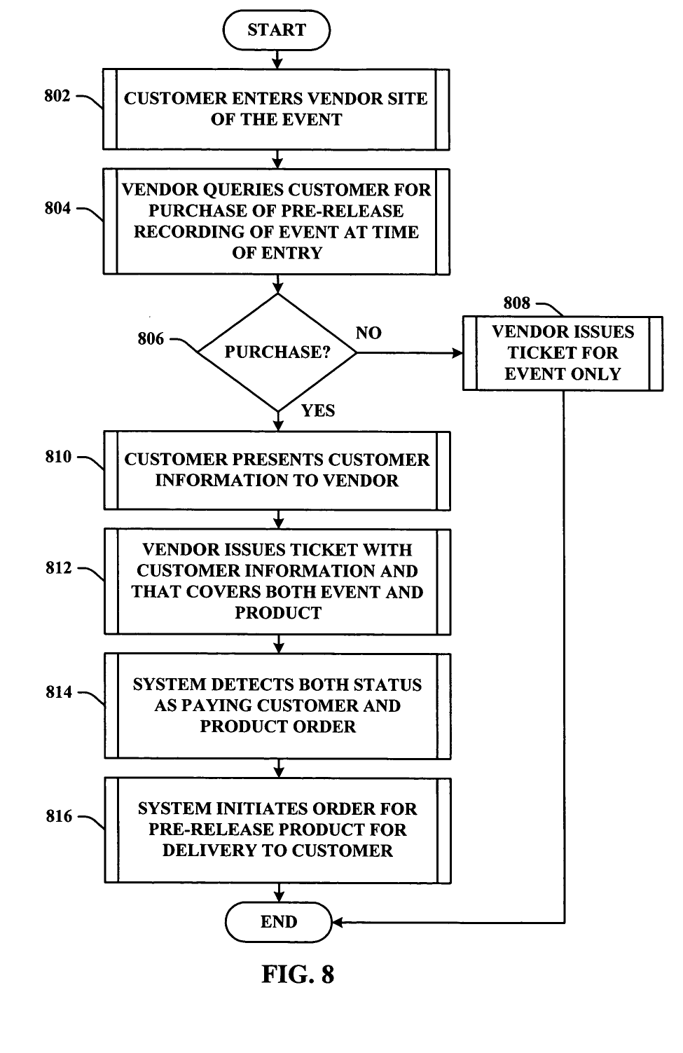

Illustrated in FIG. 8 is yet another embodiment of a methodology associated with entering and processing an electronic title order in accordance with the present innovation. At 802, a customer enters a venue corresponding to the event. By way of example, the customer can enter a cinema or movie theater corresponding to a specific event (e.g., movie).

Next, at 804, a vendor at the venue queries the customer to determine if the customer desires to order a recording of the event or production. It will be appreciated that the electronic title can be a pre-release electronic title. In other words, the electronic title is not available for public sale and/or availability and/or release date has not been announced. At 806, the system can be configured to make a determination if the customer desires to purchase the electronic title. It is contemplated that this determination can be made in any manner known in the art.

If a determination is made that the customer does not choose to purchase, the system proceeds to 808 and issues a ticket or voucher to permit the customer to attend the event. On the other hand, if at 806 the customer desires to purchase an electronic title, the system proceeds to 810 whereby the customer can optionally present customer information to the vendor. It will be appreciated that presentation of customer information can effectuated via any means known in the art (e.g., manual or automatic). By way of example, customer information can be automatically read from a magnetic strip on a credit card or other form of identification (e.g., driver's license).

At 812, a ticket or voucher is issued entitling the customer to attend the event as well as to receive a recording of at least one aspect of the event once available. In accordance with the process, at 814, the system detects both the status as a paying customer as well as the desire to initiate a product order. Finally, at 816, the system initiates the order for the pre-release electronic title for delivery to the customer.

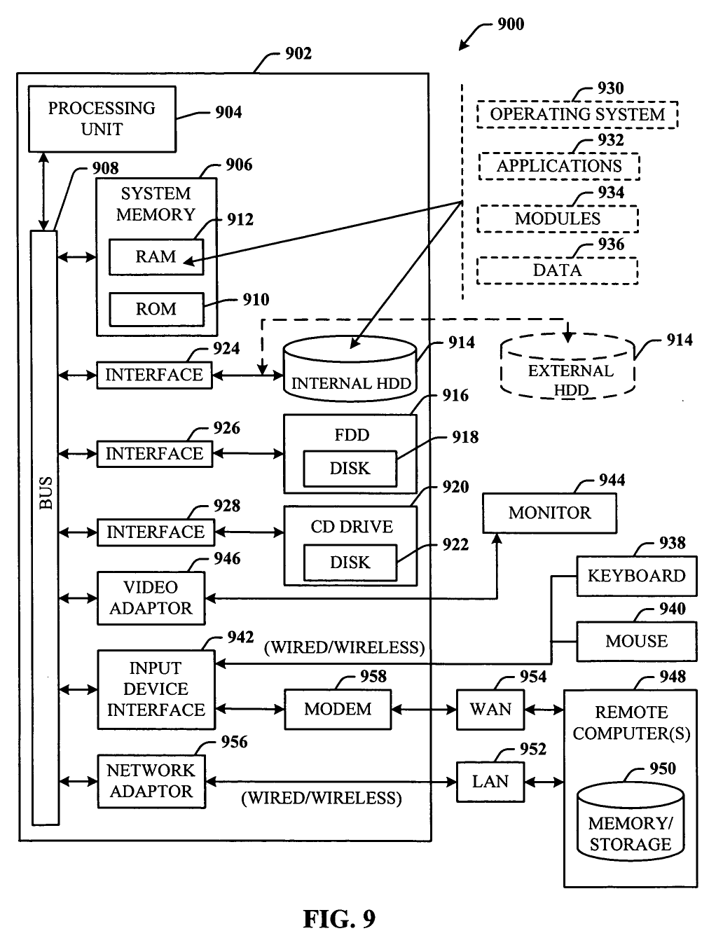

In order to provide additional context for implementing various aspects of the present invention, FIG. 9 and the following discussion is intended to provide a brief, general description of a suitable computing environment 900 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

Referring now to FIG. 9, there is illustrated a block diagram of a computer operable to execute the disclosed architecture. In order to provide additional context for various aspects of the present invention, FIG. 9 and the following discussion are intended to provide a brief, general description of a suitable computing environment 900 in which the various aspects of the present invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, there is illustrated an exemplary environment 900 for implementing various aspects of the invention that includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the present invention.

A number of program modules can be stored in the drives and RAM 912, including an operating system 930, one or more application programs 932, other program modules 934 and program data 936. All or portions of the operating system, applications, modules, and/or data can also be cached in the RAM 912.

It is appreciated that the present invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices, and companies, and facilitate enterprise-wide computer networks, such as intranets, all of which may connect to a global communication network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956. When used in a WAN networking environment, the computer 902 can include a modem 958, or is connected to a communications server on the LAN, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, with an 11 Mbps (802.11b) or 54 Mbps (802.11a) data rate or with products that contain both bands (dual band), so the networks can provide real-world performance similar to the basic 10 BaseT wired Ethernet networks used in many offices. What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method of ordering an electronic title prior to a release date for purchase or rental, the method comprising:
entering a cinema; and
initiating an order for the electronic title prior to disclosure of the release date.

2. The method set forth in claim 1, further comprising obtaining a voucher having a unique identifier.

3. The method set forth in claim 2, further comprising redeeming the voucher to initiate the order.

4. A computer readable medium having computer-executable instructions to perform the acts recited in claim 3.

5. A computer readable medium having computer-executable instructions to perform the acts recited in claim 1.

6. A system that facilitates pre-release ordering of an electronic title, the system comprising:
a pre-release order component that receives and processes a pre-release order for the electronic title prior to disclosure of a release date, wherein the release date is a date when the electronic title becomes available for purchase or rental; and
an order tracking component that monitors the process of the pre-release order.

7. The system set forth in claim 6 wherein the pre-release order component is physically located in a venue-specific location.

8. The system set forth in claim 7 wherein the venue-specific location is a cinema.

9. The system set forth in claim 6 further comprising a unique identifier that indicates an option to initiate the order.

10. The system set forth in claim 9 wherein the unique identifier is a bar code.

11. The system set forth in claim 6, further comprising a pre-release order data store that retains the pre-release order.

12. The system set forth in claim 6, further comprising an available product data store that retains a listing of at least one pre-release electronic title.

13. The system set forth in claim 6, further comprising a dispatch component that dispatches the electronic title in accordance to the pre-release order.

14. The system set forth in claim 6, further comprising a transmission component that transmits the pre-release order to a remote processing location.

15. A method of ordering an electronic title prior to release, the method comprising:
receiving a request for a product prior to disclosure of a release date;
searching availability for the product;
if the product becomes available, dispatching the product;
if the product is not available, storing the request; and
dispatching the requested product upon availability.

16. The method set forth in claim 15, further comprising initiating the request in a venue-specific location.

17. The method of claim 16 wherein the act of initiating the request comprises decoding a unique identifier.

18. The method set forth in claim 15, further comprising querying the stored requests to determine availability of the product.

19. The method set forth in claim 15, further comprising displaying at least one pre-release product.

20. The method set forth in claim 15 further comprising tendering payment.

21. The method set forth in claim 20 further comprising validating payment.

22. A computer readable medium having computer-executable instructions to perform the acts recited in claim 15.

23. A system for obtaining an electronic title prior to release, the system comprising:
means for entering a pre-release order for the electronic title prior to knowledge of a date of release for sale; and
means for processing the pre-release order.

24. The system set forth in claim 23 wherein the means for entering the pre-release order includes means for initiating the pre-release order at a venue-specific location.

25. The system set forth in claim 24 wherein the means for initiating further includes means for recognizing a unique identifier.

26. The system set forth in claim 23, further comprising means for tendering payment.

27. The system set forth in claim 23, further comprising means for querying availability of the electronic title.

28. A method of ordering an electronic title corresponding to an event, the method comprising:
entering a venue of the event;
tendering payment for an entry fee to the event;
initiating an order for the electronic title prior to a disclosure of a release date and while at the venue, wherein the electronic title is a record of one or more aspects of the event;
detecting payment of the entry fee and the act of initiating the order for the electronic title; and
initiating a delivery of the electronic title in response to the act of detecting.

29. The method set forth in claim 28 wherein the act of initiating an order is accomplished person-to-person.

30. The method set forth in claim 28, further comprising providing customer information when initiating the order.

31. The method set forth in claim 30, further comprising providing a voucher that includes the customer information.

32. The method set forth in claim 31 wherein the act of providing a voucher comprises providing a voucher with a unique identifier.

33. The method set forth in claim 28 wherein the act of entering a venue includes entering a cinema.

34. The method set forth in claim 28, further comprising attending a performance of the event.
